(19) United States
(12) Patent Application Publication
(10) Pub. No.: US 2010/0297483 A1
(43) Pub. Date: Nov. 25, 2010

(54) ELECTRIC STORAGE DEVICE AND VEHICLE

(76) Inventor: Toshiyuki Kawai, Toyohashi-shi (JP)

Correspondence Address: KENYON & KENYON LLP, 1500 K STREET N.W., SUITE 700, WASHINGTON, DC, 20005, US

(21) Appl. No.: 12/445,599

(22) PCT Filed: Jun. 20, 2008
(86) PCT No.: PCT/JP2008/061330

§ 371 Date: Apr. 15, 2009

(30) Foreign Application Priority Data
Jun. 21, 2007 (JP) 2007-164260

(51) Int. Cl. H01M 10/50

(52) U.S. Cl. 429/62; 429/120

(57) ABSTRACT

An electric storage device includes a plurality of electric storage elements each having a terminal at each end, and a support mechanism which supports the plurality of electric storage elements on both end sides of each of the electric storage elements, and a heat generator which is provided for a portion of the support mechanism that supports at least one end side of each of the electric storage elements and is capable of generating heat.

### TECHNICAL FIELD

The present invention relates to an electric storage device including a support mechanism for supporting a plurality of electric storage elements and to a vehicle equipped with the electric storage apparatus.

### BACKGROUND ART

When an assembled battery formed of a plurality of cells (secondary batteries) is used, variations in temperature between the plurality of cells lead to variations in charge and discharge characteristics between the cells. This may prevent the assembled battery from providing sufficient power output.

To address this, proposals have been made of an arrangement in which cells constituting an assembled battery are individually cooled or heated. For example, in Patent Document 1, the outer surface of an assembled battery is covered with a heat-shrinkable tube having insulation and a metallic film is formed on the surface of the heat-shrinkable tube. According to the arrangement, the metallic film allows heat transfer between the plurality of cells and promotes radiation of heat to prevent variations in temperature between the plurality of cells.

### [Patent Document 1]

Japanese Patent Publication No. 2000-58017 (CLAIMS and FIG. 1)

### DISCLOSURE OF THE INVENTION

### Problems to be Solved by the Invention

In the arrangement described in Patent Document 1, however, the heat-shrinkable tube on which the metallic film is formed must be used to cover the outer surface of the assembled battery, so that the structure and the manufacture process are complicated.

It is thus an object of the present invention to provide an electric storage device in which all of a plurality of electric storage elements can be heated generally uniformly in a simple structure.

### Means to Solve the Problems

An electric storage device according to the present invention has a plurality of electric storage elements, each of the elements having a terminal at each end; a support mechanism which supports the plurality of electric storage elements on both end sides of each of the electric storage elements; and a heat generator which is provided for a portion of the support mechanism and is capable of generating heat, the portion supporting at least one end side of each of the electric storage elements.

The heat generator may be placed around the terminal in the electric storage element. In addition, when using a connecting member for electrically connecting the terminals in the plurality of electric storage elements, the heat generator may be placed at position where the heat generator is in contact with the connecting member.

The electric storage device according to the present invention may be mounted on a vehicle. In this case, a controller and a temperature sensor are provided. The controller controls driving of the heat generator and a temperature sensor is adapted to detect a temperature of the electric storage element. The controller can drive the heat generator when a temperature detected by the temperature sensor is lower than a predetermined value. The predetermined value may be a temperature at which an output for starting the vehicle is provided in the electric storage device.

### Effects of the Invention

According to the present invention, since the heat generator is placed on at least one end side of the electric storage element, the heat generated by the heat generator can be transferred to the terminal located on at least one end side of the electric storage element to heat the electric storage element efficiently. In addition, the heat generator is only provided for the support mechanism which supports the plurality of electric storage elements, so that the structure can be simplified.

### BRIEF DESCRIPTION OF DRAWINGS

FIG. 1 A section view showing the configuration of a battery pack which is Embodiment 1 of the present invention.

FIG. 2 A section view showing the structure for supporting a cell.

FIG. 3 A schematic diagram showing an exemplary arrangement of an electric heater.

FIG. 4 A block diagram showing a circuit configuration for controlling driving of the electric heater.

FIG. 5 A flow chart showing driving control of the electric heater.

FIG. 6 A diagram showing a relationship between a temperature and a power output in the cell.

### BEST MODE FOR CARRYING OUT THE INVENTION

A preferred embodiment of the present invention will hereinafter be described.

### Embodiment 1

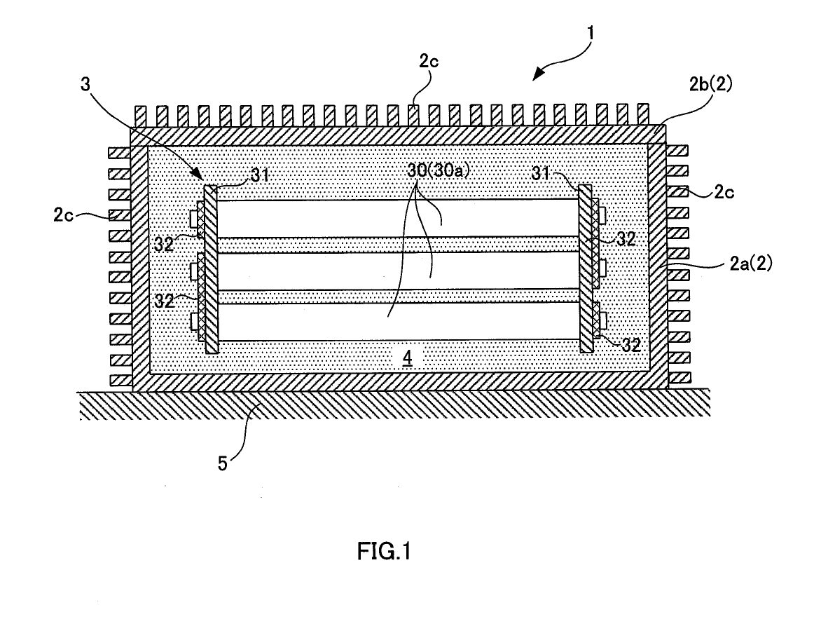

The configuration of a battery pack (electric storage device) which is Embodiment 1 of the present invention will hereinafter be described with reference to FIG. 1. FIG. 1 is a section view showing the configuration of the battery pack according to Embodiment 1. The battery pack of Embodiment 1 is mounted on a vehicle.

The battery pack 1 of Embodiment 1 includes a battery case 2, a battery unit 3 housed in the battery case 2, and a heat exchange medium 4 in fluid form.

The battery case 2 includes a first case member 2a which provides space for accommodating the battery unit 3 and the heat exchange medium 4, and a second case member 2b which serves as a lid fixed to the first case member 2a. The second case member 2b is secured to the first case member 2a with a fastening member (not shown) such as bolts, welding or the like. This hermetically seals the battery case 2.

The first case member 2a is fixed to a vehicle body 5 with a fastening member (not shown) such as bolts, welding or the like. This brings the bottom surface of the battery case 2 into contact with the surface of the vehicle body 5. Examples of the vehicle body 5 include a floor panel, a floor pan, or a vehicle frame.

A plurality of heat-radiating fins 2c for enhancing heat radiation of the battery pack 1 are provided on the outer surface of the battery case 2. The heat-radiating fins 2c may not be provided. The first case member 2a and the second case member 2b are preferably made of a material having high durability and corrosion resistance. Specifically, as the material, it is possible to use metal such as aluminum.

The battery unit 3 includes an assembled battery 30 consisting of a plurality of cells (electric storage elements) 30a, and two support members 31 for supporting the assembled battery 30 (specifically, supporting the respective cells 30a at both ends thereof). Each of the cells 30a is electrically and mechanically connected to the adjacent cell 30a via a bus bar (connecting member) 32. In other words, the plurality of cells 30a are connected electrically in series via the bus bar 32 to provide high power output (for example, 200 V).

Wires (not shown) for a positive electrode and a negative electrode are connected to the assembled battery 30. The wires pass through the battery case 2 and are connected to an electronic device (for example, a motor for use in running the vehicle or an inverter for use in driving the motor) placed outside the battery case 2.

In Embodiment 1, a cylindrical secondary battery is used as the cell 30a. Examples of the secondary battery include a nickel metal hydride (NiMH) battery, a lithium-ion battery and the like. The shape of the cell 30a is not limited to the cylinder, and other forms such as a square may be used. While the secondary battery is used in Embodiment 1, an electric double layer capacitor (condenser) may be used instead of the secondary battery.

The heat exchange medium 4 is in contact with the outer peripheral surface of the assembled battery 30 (each of the cells 30a) and the inner wall surface of the battery case 2. When the assembled battery 30 generates heat due to charge and discharge thereof, the heat exchange medium 4 in contact with the assembled battery 30 exchanges heat with the assembled battery 30 to prevent an increase in temperature of the assembled battery 30. After the heat exchange medium 4 exchanges heat with the assembled battery 30, the heat exchange medium 4 is naturally convected within the battery case 2 to come into contact with the inner wall surface of the battery case 2. This causes the heat of the heat exchange medium 4 to be transferred to the battery case 2, and then the heat is released outside (into the air) via the battery case 2 or is directed to the vehicle body 5.

While the heat exchange medium 4 is naturally convected with the help of the temperature difference in Embodiment 1, the present invention is not limited thereto. For example, it is possible to place a stirring member (so-called fan) for forcedly flowing the heat exchange medium 4 in the battery case 2.

An insulating oil or an inert fluid can be used as the heat exchange medium 4. An example of the insulating oil is silicone oil. As the inert fluid (fluid having insulation), it is possible to use Fluorinert, Novec HFE (hydrofluoroether), and Novec1230 (manufactured by 3M) which are fluorochemical inert fluid.

While the heat exchange medium 4 in fluid form is used in Embodiment 1, a gas such as air and nitrogen can be used instead of the fluid.

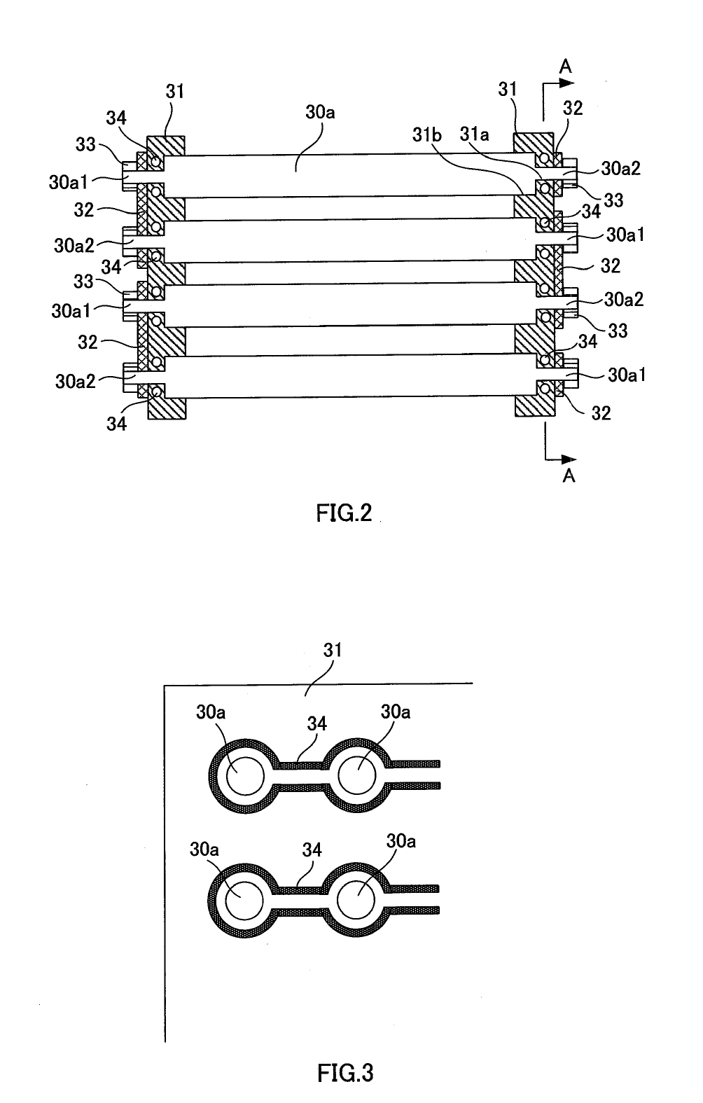

The support members 31 support the respective cells 30a at both ends as shown in FIG. 2. The support member 31 includes hole portions 31a through which a positive electrode terminal 30a1 and a negative electrode terminal 30a2 formed at both ends of each cell 30a pass, and concave portions 31b which engage with both end portions of the cell 30a excluding the terminals 30a1 and 30a2. The hole portion 31a is formed in part of the concave portion 31b. The support member 31 supports each cell 30a mainly on the concave portion 31b.

While the two support members 31 formed independently as separate components are used in Embodiment 1, these support members may be formed into one component.

Regarding the portions of the terminals 30a1 and 30a2 of the cell 30a that protrude from the hole portions 31a of the support member 31, the terminals 30a1 and 30a2 of the cell 30a are electrically and mechanically connected to the terminals 30a1 and 30a2 of the adjacent cell 30a via the bus bar 32. A bolt 33 for fixing the bus bar 32 is placed on each end of the terminals 30a1 and 30a2.

The terminals 30a1 and 30a2 are electrically connected only to the bus bar 32 and are not in contact with the support member 31 (hole portion 31a).

An electric heater (heat generator) 34 is provided in the portion of the support member 31 that is placed on the outer periphery of each of the terminals 30a1 and 30a2 of the cell 30a. In other words, the electric heater 34 is embedded in the support member 31. The electric heater 34 is formed of a single wire and is placed to surround the terminals 30a1 and 30a2 of the cell 30a as shown in FIG. 3. FIG. 3 is a section view taken along a line A-A in FIG. 2.

The electric heater 34 is designed such that it can heat all of the terminals 30a1 and 30a2 when the electric heater 34 is energized to generate heat. Specifically, the electric heater 34 can be formed in a known configuration by using a heating wire or PTC (Positive Temperature Coefficient).

The electric heater 34 is connected to a power source placed outside the battery pack 1 via wiring, not shown. A so-called auxiliary battery (lead-acid battery) can be used as the power source. The electric heater 34 can be supplied with power from the power source to generate heat.

While the electric heater 34 is embedded in the support member 31 in Embodiment 1, the present invention is not limited thereto. Particularly, it is essential only that the electric heater 34 can heat the terminals 30a1 and 30a2 of the cells 30 and that the electric heater 34 is placed close to the terminals 30a1 and 30a2.

Specifically, instead of the configuration described in Embodiment 1, the electric heater 34 can be placed in the portion of the support member 31 that is in contact with the cell 30a, that is, on the surface of the hole portion 31a or the concave portion 31b described above. It is also possible to heat the bus bar 32 which is connected to the terminals 30a1 and 30a2. In this case, the terminals 30a1 and 30a2 can be heated via the bus bar 32. Specifically, the electric heater 34 can be placed between the bus bar 32 and the support member 31.

While Embodiment 1 is described in conjunction with the electric heater 34 placed in each of the two support members 31 which support the plurality of cells 30a at both ends thereof, the present invention is not limited thereto. Specifically, the electric heater 34 can be placed only in one of the two support members 31. In this case, the electric heater 34 heats the terminals placed on the side supported by the one of the support members 31 (the terminals of the cells 30a on one side). The electric heater 34 can be provided for one of the support members 31 in this manner to reduce the power consumption when the electric heater 34 is used to heat the assembled battery 30.

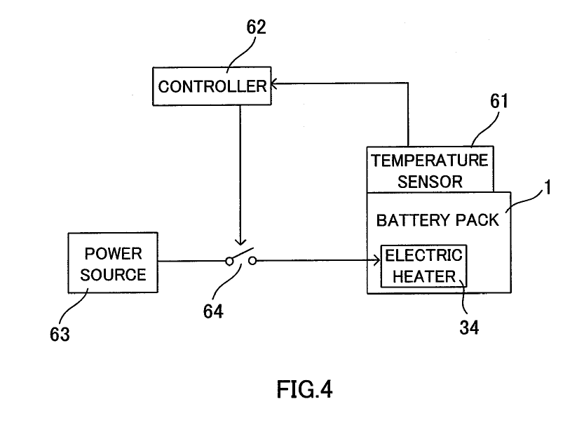

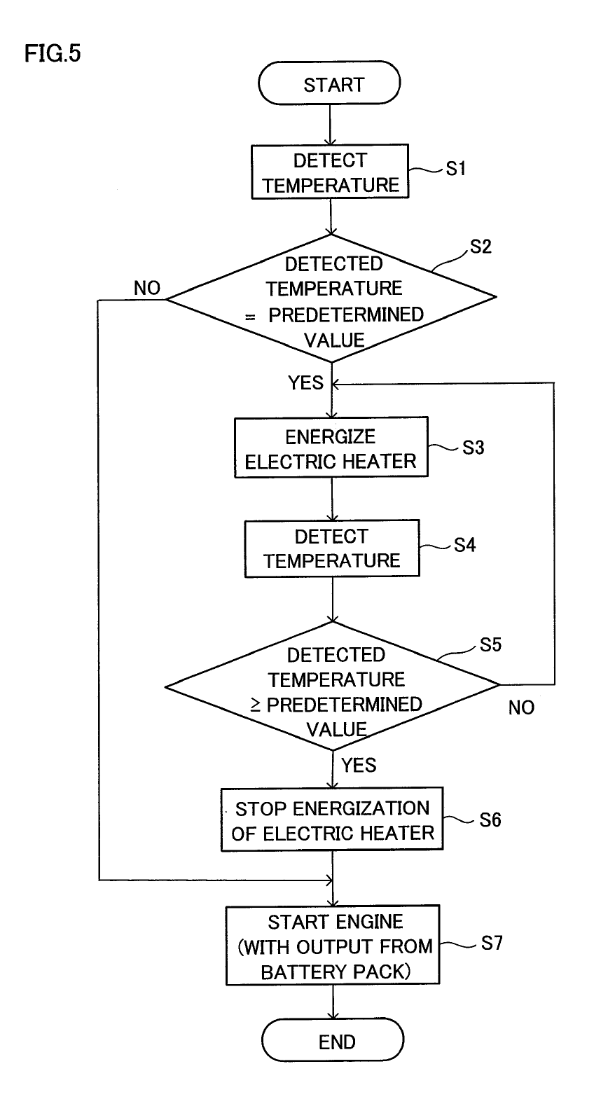

Next, the circuit configuration for controlling the battery pack 1 of Embodiment 1 will be described with reference to FIG. 4.

In FIG. 4, a temperature sensor 61 is provided for the battery pack 1 to detect the temperature of the battery pack 1 (assembled battery 30). An output signal from the temperature sensor 61 is input to a controller 62. The controller 62 may double as a controller for controlling the running and the like of the vehicle.

While the temperature sensor 61 is used to detect the temperature of the battery pack 1 in Embodiment 1, the present invention is not limited thereto. Any configuration may be used as long as the temperature of the battery pack 1 can be directly or indirectly detected.

On the other hand, the controller 62 controls the driving (energization or de-energization) of the electric heater 34 provided for the support member 31 within the battery pack 1. Specifically, the controller 62 controls ON/OFF of a switch 64 provided on wiring which connects the electric heater 34 with a power source (power source of the electric heater 34) 63. When the switch 64 is ON, the power of the power source 63 is supplied to the electric heater 34 to heat the battery pack 1 (assembled battery 30). On the other hand, when the switch 64 is OFF, electric current through the electric heater 34 is interrupted.

While Embodiment 1 is described in conjunction with the case where the power source (so-called auxiliary battery) different from the assembled battery 30 is used as the power source 63 of the electric heater 34, the present invention is not limited thereto. Specifically, the assembled battery 30 may be used as the power source of the electric heater 34. In this case, the power output from the assembled battery 30 can be supplied directly to the electric heater 34 or the high-voltage value output from the assembled battery 30 can be converted into a low-voltage value by a DC/DC converter before supply to the electric heater 34.

Next, the control operation of the controller 62 described above will be described with reference to FIG. 5. FIG. 5 is a flow chart showing the control operation of the controller 62 to illustrate the operation in starting the vehicle equipped with the battery pack 1 of Embodiment 1.

At step S1, the controller 62 detects the temperature of the battery pack 1 based on the output from the temperature sensor 61. At step S2, it is determined whether or not the temperature detected at step S1 is equal to or lower than a predetermined value. The predetermined value is a preset temperature for starting the vehicle through the use of the output from the battery pack 1. In other words, the predetermined value refers to the temperature when the output for starting the vehicle is provided.

If the detected temperature is equal to or higher than the predetermined value at step S2, the flow proceeds to step S3, or to step S7 if not.

At step S3, the controller 62 changes the switch 64 from the OFF state to the ON state, so that the controller 62 energizes the electric heater 34 by using the output from the power source 63. At step S4, the controller 62 again detects the temperature of the battery pack 1 based on the output from the temperature sensor 61.

At step S5, it is determined whether or not the temperature detected at step S4 is equal to or higher than the predetermined value. The predetermined value is identical to the predetermined value described in the processing at step S2. If the detected temperature is equal to or higher than the predetermined value, the flow proceeds to step S6. If not, the flow returns to step S3 to continue the energization of the electric heater 34.

At step S6, the controller 62 changes the switch 64 from the ON state to the OFF state to stop the energization of the electric heater 34. Then, at step S7, the controller 62 starts the vehicle (engine) by using the output from the battery pack 1. In other words, the ignition switch becomes the ON state.

While the vehicle is started after the stop of the energization of the electric heater 34 in Embodiment 1, the present invention is not limited thereto. The energization of the electric heater 34 may be stopped after the vehicle is started. While the operation in starting the vehicle is described with reference to the flow chart shown in FIG. 5, the present invention is not limited thereto. The assembled battery 30 (cells 30a) may be heated by using the electric heater 34 while the vehicle is running.

While the temperature of the battery pack 1 is again detected after the energization of the electric heater 34 in the flow chart shown in FIG. 5, the present invention is not limited thereto. For example, it is possible to start the vehicle through the use of the output from the battery pack 1 after the lapse of a predetermined time period from the energization of the electric heater 34. The predetermined time period refers to a time period for indirectly determining that the temperature of the battery pack 1 reaches the above-mentioned predetermined value (temperature described at steps S2 and S5) due to the heat generated by the electric heater 34. In other words, it is assumed that the lapse of the predetermined time periods means that the temperature of the battery pack 1 reaches the above-mentioned predetermined value.

On other hands, if the remaining battery capacity (so-called SOC (State Of Charge)) of the battery pack 1 (assembled battery 30) is higher than a predetermined value, the output from the battery pack 1 can be used to energize the electric heater 34. In general, the battery pack 1 is charged and discharged such that the SOC of the battery pack 1 for use in running the vehicle remains within the upper limit (for example, 80%) and the lower limit (for example, 40%) which are previously set. The battery pack 1 can be discharged to energize the electric heater 34 if the SOC of the battery pack 1 is sufficiently higher than the abovementioned upper limit. The output in discharging the battery pack 1 can be used to drive the electric heater 34.

According to Embodiment 1, the electric heater 34 is provided in the support members 31 for supporting the cells 30a at both ends thereof, that is, the sides of the cell 30a where the terminals 30a1 and 30a2 are placed, to heat the terminals 30a1 and 30a2 of the cell 30a. This can heat all of the cells 30a constituting the assembled battery 30 generally uniformly. In addition, since the electric heater 34 is not provided for each of the cells 30a constituting the assembled battery 30 but provided only for the pair of support members 31, the structure can be simplified. In other words, it is essential only that the electric heater 34 is provided for the support member 31 in contrast to the conventional configuration of the battery pack provided with the support member 31, so that the manufacture process of the battery pack 1 of Embodiment 1 is not complicated.

Whether the cells 30a are partially heated as in Embodiment 1 or whether the cells 30a are wholly heated, the cells 30a have substantially the same output characteristics (show substantially the same changes in output over time) if the cells 30a are heated with a predetermined amount of heat (amount of heat generated by the electric heater 34). Thus, the heating of the terminals 30a1 and 30a2 of the cells 30a is sufficient as in Embodiment 1. In addition, since the cell 30a has an arrangement in which an electric generation element is covered with a case, the electric generation element cannot be heated efficiently if any portion of the cell 30a other than the terminals is heated. The electric generation element refers to an element which includes a positive electrode, a negative electrode, and an electrolyte, and which can be charged and discharged.

Since the terminals 30a1 and 30a2 of the cells 30 are heated in Embodiment 1, the cells 30a can be heated efficiently. Specifically, the terminals 30a1 and 30a2 are connected to the electric generation element placed within the cells 30a, so that the heating of the terminals 30a1 and 30a2 allows the electric generation element to be heated efficiently.

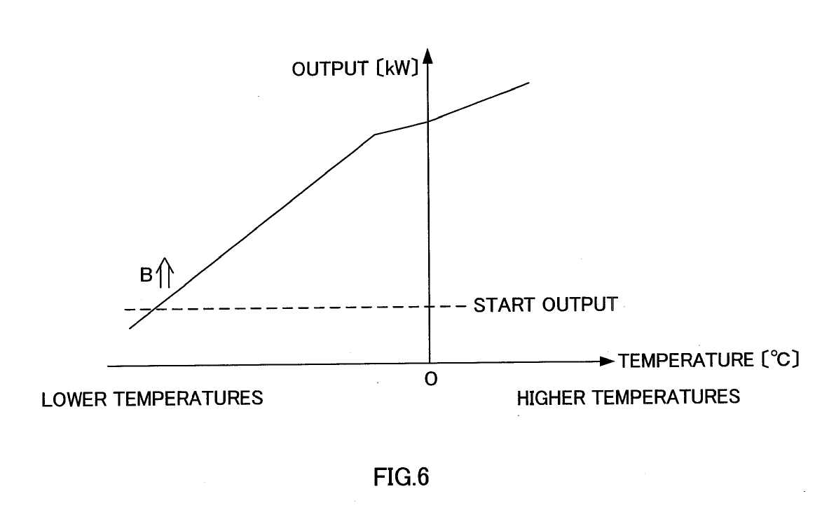

The cell 30a generally tends to provide a lower output as the temperature is lower. Particularly, if a lithium-ion battery is used as the cell 30a, the tendency is significantly found. FIG. 6 shows a (illustrative) relationship between the temperature and output in the cell 30a.

As shown in FIG. 6, the cell 30a provides a lower output as the temperature is lower. If the output (hereinafter referred to as a start output) shown by a dotted line in FIG. 6 is required as the output for starting the vehicle, the vehicle cannot be started at an output lower than the start output.

No problem occurs if the output of the battery pack 1 is higher than the start output at lower temperatures. It is contemplated that the capacity of the assembled battery 30 (cells 30a) is previously increased for achieving such a high output. Specifically, if the capacity of the cell 30a is increased, the characteristic shown in FIG. 6 can be changed in a direction indicated by an arrow B to provide the output of the battery pack 1 at lower temperatures that is higher than the start output. In this case, however, the increased capacity of the cell 30 results in an increased size of the cell 30a, and thus the battery pack 1 is also increased in size.

On the other hand, if the electric heater 34 is used to heat the cells 30 as in Embodiment 1, the output from the battery pack 1 can be higher than the start output, so that the vehicle can be started at lower temperatures. In this case, since the capacity of the cell 30a does not need to be increased, the cell 30a or the battery pack 1 is not increased in size.

1. An electric storage device comprising:
a plurality of electric storage elements, each of the elements having a terminal at each end;
a support mechanism which supports the plurality of electric storage elements on both end sides of each of the electric storage elements; and
a heat generator which is provided for a portion of the support mechanism and is capable of generating heat, the portion supporting at least one end side of each of the electric storage elements,
wherein the heat generator is placed around the terminal in the electric storage element.

2. (canceled)

3. The electric storage device according to claim 1, wherein the heat generator is embedded in the support mechanism.

4. The electric storage device according to claim 1, further comprising a connecting member for electrically connecting the terminals in the plurality of electric storage elements,
wherein the heat generator is in contact with the connecting member.

5. The electric storage device according to claim 1, wherein the heat generator is formed of a single wire.

6. The electric storage device according to claim 5, wherein the wire is placed along an outer periphery of the terminal in the electric storage element.

7. The electric storage device according to claim 1, further comprising:
a heat exchange medium in fluid form which exchanges heat with the electric storage element; and
a case which accommodates the electric storage element, the support mechanism, and the heat exchange medium.

8. A vehicle comprising:
the electric storage device according to claim 1;
a controller which controls driving of the heat generator; and
a temperature sensor which is adapted to detect a temperature of the electric storage element,
wherein the controller drives the heat generator when a temperature detected by the temperature sensor is lower than a predetermined value.

9. The vehicle according to claim 8, wherein the predetermined value is a temperature at which an output for starting the vehicle is provided in the electric storage device.
